(19) United States
(12) Patent Application Publication
(10) Pub. No.: US 2022/0345883 A1
(43) Pub. Date: Oct. 27, 2022

(54) SECURITY KEY UPDATES IN DUAL CONNECTIVITY

(71) Applicant: GOOGLE LLC, Mountain View, CA (US)

(72) Inventor: Chih-Hsiang Wu, Taoyuan City (TW)

(21) Appl. No.: 17/635,376

(22) PCT Filed: Aug. 13, 2020
(86) PCT No.: PCT/US20/46160

§ 371 Date: Feb. 15, 2022

Related U.S. Application Data
(60) Provisional application No. 62/887,351, filed on Aug. 15, 2019.

(51) Int. Cl. H04W 12/0433; H04W 12/041; H04W 36/00

(52) U.S. Cl. CPC H04W 12/0433; H04W 12/041; H04W 36/0038; H04W 36/0069

(57) ABSTRACT

A base station security communicates with a UE operating as an SN in dual connectivity of the UE with a first MN and the SN. The base station communicates with the UE over a radio interface using a first security key (802). The base station then receives, from a second MN, a first message including data for obtaining a second security key for communicating with the UE (804) and suspends application of the second security key to downlink traffic to the UE until a second message is received (806). In response to receiving the second message, base station communicates with the UE over the radio interface using the second security key (808).

### FIELD OF THE DISCLOSURE

This disclosure relates generally to wireless communications and, more particularly, to using security keys in dual connectivity scenarios.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP TS 36.360) and New Radio (NR) (see TS 38.323) provides sequencing of protocol data units (PDUs) in the uplink direction (from a user equipment (UE) to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages and use DRBs to transport data on a user plane.

UEs can use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). So-called SRB1 resources carry RRC messages, which in some cases include non-access stratum (NAS) messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN and the SN. Further, using the lower-layer resources of only the MN can be referred as MCG DRBs, DRBs using the lower-layer resources of only the SN can be referred as SCG DRBs, and DRBs using the lower-layer resources of both the MCG and the SCG can be referred to as split DRBs.

To protect confidentiality and integrity of traffic (i.e., prevent inspection in the event of unauthorized interception and alteration, respectively), network devices operating in cellular networks utilize various security keys. For example, a 5G cellular network supports a hierarchy of security keys for communicating with certain network nodes (e.g., 5G Node Bs (gNBs) operating in the radio access network (RAN) or an Access and Mobility Management Function (AMF) operating in a core network), communicating certain types of information (e.g., control-plane data, user-plane data), and providing a particular security feature (e.g., confidentiality protection through encryption, integrity protection).

As a more specific example, a UE can use keys such as K_{UPenc} to encrypt user-plane data transmitted over a DRB, K_{UPint} to protect integrity of user-plane data transmitted over a DRB, K_{RRCenc} to encrypt RRC data transmitted over an SRB, and K_{RRCint} to protect integrity of radio resource control (RRC) data transmitted over an SRB. The UE and the gNB can derive these keys at least partially from RAN keys associated with RAN nodes. Thus, a gNB operating in a RAN can be associated with a key K_{gNB}, an eNB operating in the RAN can be associated with a key K_{eNB}, etc. In accordance with the security key hierarchy, network devices in turn can generate RAN keys based on other keys which the core network can control (e.g., K_{AMF} or next hop key NH), based on previous values of the RAN keys, RAN-level counters, etc.

When the UE operates in DC with a gNB and an eNB base station, or dual connectivity with multiple gNBs, the UE uses security keys specific to the master node (MN) as well as security keys specific to the secondary node (SN). In some cases, the RAN performs an inter-MN handover without a change in the SN, so that the UE begins to communicate with a “new” (or “target”) MN rather than the “old” (or “source”) MN, and the same SN. The new MN in this case provides to the SN a new SN key using which the SN can derive a new security key for communicating with the UE. However, the UE and the SN in accordance with 3GPP TS 37.340 v15.6.0 do not always switch over from the old security key to the new security key and, as a result, the UE and the SN cannot support encryption for at least a period of time, which in turn results in an interruption of service.

### SUMMARY

When a RAN performs an inter-MN handover of a UE while retaining the same SN for dual connectivity, the SN of this disclosure begins to apply a new security key only when the determines that the UE possesses the matching (e.g., same) key. The SN thereby ensures that the UE and the RAN align the security keys. In particular, after the SN receives, from the new MN, data (e.g., a RAN key) for generating a new security key for communicating with the SN, the SN begins to apply the new security key only in response to a subsequent event (“key alignment event”).

In various implementations, the key alignment event can be completion of a channel access procedure between the UE and the SN, receiving a certain message from the old MN or the new MN, or receiving a certain message from the UE. In some implementations, the SN does not communicate with the UE, at least in the downlink direction, after receiving the data for the new security key but prior to detecting the key alignment event. In other implementations, the SN continues to communicate with the UE using the “old” security key during this interval. Further, the SN in some case switches from the old security key to the new security key at different times for the downlink and uplink communications.

An example embodiment of these techniques is a method for secure communication at a base station operating as an SN for a UE in dual connectivity with a first MN and the SN. The method includes communicating with the UE over a radio interface using a first security key, receiving a first message including data for obtaining a second security key for communicating with the UE, from a second MN, and suspending application of the second security key to downlink traffic to the UE until a second message is received. In response to receiving the second message, the method includes communicating with the UE over the radio interface using the second security key.

Another example embodiment of these techniques is base station including processing hardware and configured to implement the method above.

A further embodiment of these techniques is a method for secure communication in a UE operating in dual connectivity with a first MN and an SN. The method includes communicating with the SN over a radio interface using a first security key, receiving security configuration including data for obtaining a second security key for communicating with the SN, suspending application of the second security key to uplink traffic to the SN until a second message is received, and, in response to receiving the second message, communicating with the SN over the radio interface using the second security key.

Another example embodiment of these techniques is UE including processing hardware and configured to implement the method above.

### BRIEF DESCRIPTION OF THE DRAWINGS

FIG. 1 is a block diagram of an example system in which a radio access network (RAN) can implement the techniques of this disclosure for managing security keys associated with a user equipment (UE) operating in dual connectivity (DC) with a source master node (MN) and a secondary node (SN) and, after an inter-MN handover, a target MN and the SN;

FIG. 2A is a block diagram of a protocol stack according to which the UE of FIG. 1 communicates with base stations;

FIG. 2B illustrates a fragment of a security key hierarchy according to which the devices of FIG. 1 can operate;

FIG. 3 is a messaging diagram of an example scenario in which the SN of FIG. 1 stops applying the old security key, suspends communications with the UE until a certain event, and starts applying the new security upon detecting the event;

FIG. 4 is a messaging diagram of an example scenario in which the SN of FIG. 1 continues to apply the old security key until the UE and the SN complete a random access procedure;

FIG. 5 is a messaging diagram of an example scenario in which the SN of FIG. 1 starts applying the new security key upon receiving a certain media access channel (MAC) protocol data unit (PDU) or a transmission on a Physical Uplink Control Channel (PUCCH);

FIG. 6 is a messaging diagram of an example scenario in which the SN of FIG. 1 notifies the UE of the switch to the new security key via a control PDU or a data PDU;

FIG. 7 is a messaging diagram of an example scenario in which the SN of FIG. 1 notifies the UE of the switch to the new security key for downlink traffic via a control PDU or a data PDU, and the UE notifies the SN of the switch to the new security key for uplink traffic via a control PDU or a data PDU;

FIG. 8 is an example method for managing a security key for communicating with a UE that goes through an inter-MN handover, which can be implemented in the SN of FIG. 1; and

FIG. 9 is an example method for managing a security key for communicating with an SN when a UE goes through an inter-MN handover, which can be implemented in the UE of FIG. 1.

### DETAILED DESCRIPTION OF THE DRAWINGS

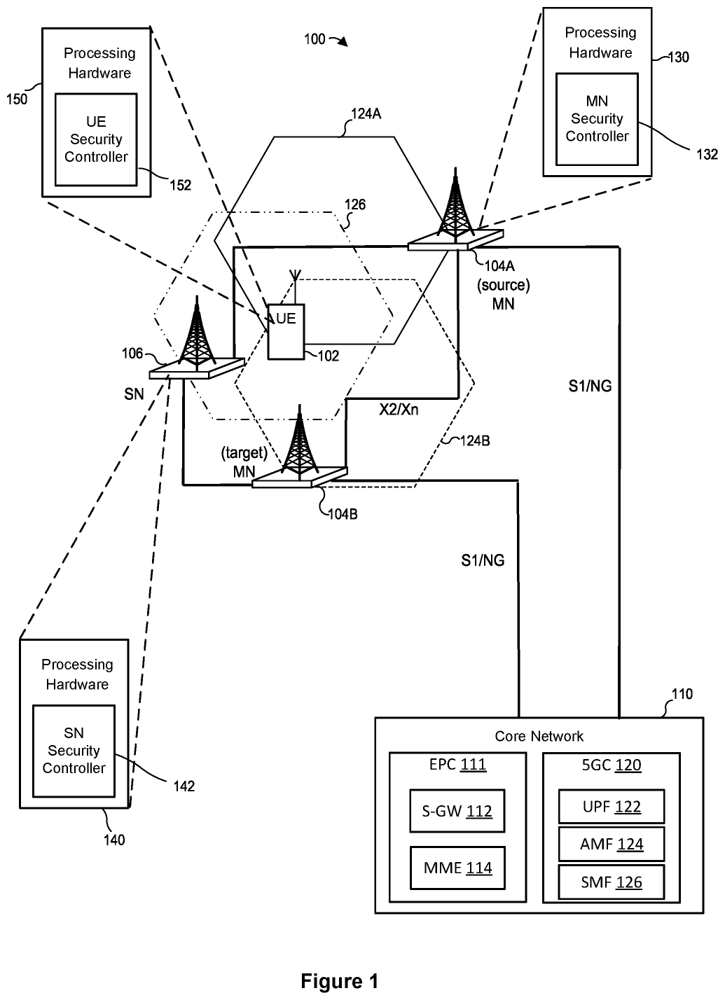

FIG. 1 depicts an example wireless communication system 100 in which a UE 102 initially operates in DC with a base station 104A and a base station 106 and, after an inter-MN handover, continues to operate in DC with a base station 104B and the base station 106. As discussed above, the base stations 104A and 104B operate as a source master node (S-MN) and a target master node (T-MN), respectively, and the base station 106 operates as a secondary node (SN) both prior to and after the inter-MN handover.

The UE 102 and the base station 106 implement the secure communication techniques of this disclosure and, in particular, update security keys so that the UE 102 and the base station 106 apply the same keys (or, more generally, compatible keys) to transmit and receive data. Further, the UE 102 and the base station 106 apply the techniques of this disclosure to reduce or entirely eliminate service interruptions, or periods of time when the UE 102 cannot communicate with the base station 106.

In different configurations of the wireless communication system 100, the base station 104A and the base station 104B can be implemented as a master eNB (MeNB) or a master gNB (MgNB) node, and the base station 106 can be implemented as a secondary eNB (SeNB) or a secondary gNB (SgNB) node. The UE 102 communicates with the base station 104A and the base station 106 via the same RAT such as EUTRA or NR, or different RATs. The UE 102 communicates with the base station 104B and the base station 106 via the same RAT or different RATs. In some cases, an MeNB or an SeNB is implemented as an ng-eNB rather than an eNB. When the base station 104A or the base station 104B is an Mng-eNB and the base station 106 is a SgNB, the UE 102 may be in next generation (NG) EUTRA-NR DC (NGEN-DC) with the Mng-eNB and the SgNB. When the base station 104A or the base station 104B is an MgNB and the base station 106 is an SgNB, the UE 102 may be in NR-NR DC (NN-DC) with the MgNB and the SgNB. When the base station 104A or the base station 104B is an MgNB and the base station 106 is an Sng-eNB, the UE 102 may be in NR-EUTRA DC (NE-DC) with the MgNB and the Sng-eNB.

The base station 104A, 104B, and 106 can connect to the same core network (CN) 110 which can be an evolved packet core (EPC) 111 or a fifth-generation core (5GC) 120. The base station 104A and/or base station 104B can be implemented as an eNB supporting an S1 interface for communicating with the EPC 111, an ng-eNB supporting an NG interface for communicating with the 5GC 120, or as a base station that supports the NR radio interface as well as an NG interface for communicating with the 5GC 120. The base station 106 can be implemented as an en-gNB with an Si interface to the EPC 111, an en-gNB that does not connect to the EPC 111, or a base station that supports the NR radio interface as well as an NG interface to the 5GC 120. To directly exchange messages during the scenarios discussed below, the base stations 104A, 104B, and 106 can support an X2 or Xn interface.

Among other components, the EPC 111 can include a Serving Gateway (S-GW) 112 and a Mobility Management Entity (MME) 114. The S-GW 112 in general is configured to transfer user-plane packets related to audio calls, video calls, Internet traffic, etc., and the MME 114 is configured to manage authentication, registration, paging, and other related functions. The 5GC 120 includes a User Plane Function (UPF) 122 and an Access and Mobility Management (AMF) 124, and/or Session Management Function (SMF) 126. Generally speaking, the UPF 122 is configured to transfer user-plane packets related to audio calls, video calls, Internet traffic, etc., the AMF 124 is configured to manage authentication, registration, paging, and other related functions, and the SMF 126 is configured to manage PDU sessions.

As illustrated in FIG. 1, the base station 104A supports a cell 124A, the base station 104B supports a cell 124B, and the base station 106 supports a cell 126. The cells 124A and 126 can partially overlap, as can the cells 124B and 126, so that the UE 102 can communicate in DC with the base station 104A (operating as an S-MN) and the base station 106 (operating as an SN) and, upon completing an inter-MN handover, with the base station 104B (operating as an T-MN) and the SN 106. More particularly, when the UE 102 is in DC with the base station 104A and the base station 106, the base station 104A operates as an MeNB, a Mng-eNB or a MgNB, and the base station 106 operates as an SgNB or an Sng-eNB.

In general, the wireless communication network 100 can include any suitable number of base stations supporting NR cells and/or EUTRA cells. More particularly, the EPC 111 or the 5GC 120 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies.

With continued reference to FIG. 1, the base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 120 in an example implementation includes an MN security controller 132 configured to manage one or more master security keys when the base station 104A operates as an MN. The base station 104B can have a similar implementation.

In operation, the MN security controller 132 can access and, in some cases, update the current values of various security keys. For example, the MN security controller 132 can operate on a RAN key K_{MN} associated with the base station 104A, a RAN key K_{SN} associated with the base station 106, the AMF key K_{AMF}, and the next hop key NH. To communicate with the UE 102, the MN security controller 132 can retrieve from the memory, update, and otherwise manage a first set of control-plane security keys K_{RRCint} and K_{RRCenc} as well as user-plane security keys K_{UPint}, and K_{UPenc} In some scenarios, the MN security controller 132 has only a subset of the security keys for communicating of the UE 102. Depending on the implementation, the key K_{MN} can be a K_{gNB} or a K_{eNB}, and the key K_{SN} can be a secondary K_{gNB} (S-K_{gNB}) or a secondary K_{eNB} (S-K_{eNB}).

The base station 106 is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes an SN security controller 142 configured to manage one or more secondary security keys when the base station 106 operates as an SN.

Similar to the MN security controller 132, the SN security controller 142 can operate on a RAN key K_{MN} associated with the base station 104A, another RAN key K_{MN} associated with the base station 104B, a RAN key K_{SN} associated with the base station 106, the AMF key K_{AMF}, and the next hop key NH. To communicate with the UE 102, the SN security controller 142 can retrieve, update, and otherwise manage a second set of control-plane security keys K_{RRCint} and K_{RRCenc} as well as user-plane security keys K_{UPint}, and K_{UPenc}, which the base station 106 can store in its memory. In some scenarios, the SN security controller 142 has only a subset of the security keys for communicating of the UE 102. Depending on the implementation, the key K_{MN} can be a K_{gNB} or a K_{eNB}, and the key K_{SN} can be a S-K_{gNB} or S-K_{eNB}.

Although FIG. 1 illustrates the security controllers 132 and 142 as operating in an MN and a SN, respectively, a base station generally can operate as an MN or an SN in different scenarios. Thus, the MN 104A, the MN 104B, and the SN 106 can implement similar sets of functions and support both MN and SN operations.

Still referring to FIG. 1, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an UE security controller 152 configured to manage one or more UE security keys.

The UE security controller 152 can receive, store, and utilize such RAN keys as key K_{MN} associated with the base station 104A, another key K_{MN} associated with the base station 104B, and key K_{SN} associated with the base station 106. To communicate with the MN 104A, the UE security controller 152 can retrieve, update, and otherwise manage a first set of control-plane security keys K_{RRCint} and K_{RRCenc} as well as user-plane security keys K_{UPint} and K_{UPenc}; to communicate with the MN 104B, the UE security controller 152 can retrieve, update, and otherwise manage a second set of control-plane security keys K_{RRCint} and K_{RRCenc} as well as user-plane security keys K_{UPint} and K_{UPenc}; and to communicate with the SN 106, the UE security controller 152 can retrieve, update, and otherwise manage a third set of control-plane security keys K_{RRCint} and K_{RRCenc} as well as user-plane security keys K_{UPint} and K_{UPenc} In some scenarios, the UE security controller 152 has only a subset of the security keys for communicating of the UE 102.

In operation, the UE 102 can use a radio bearer (e.g., a DRB or a SRB) that at different times terminates at the MN 104A or the SN 106. The UE 102 can apply one or more security keys when communicating on the radio bearer, in the uplink (from the UE 102 to a base station) and/or downlink (from a base station to the UE 102) direction.

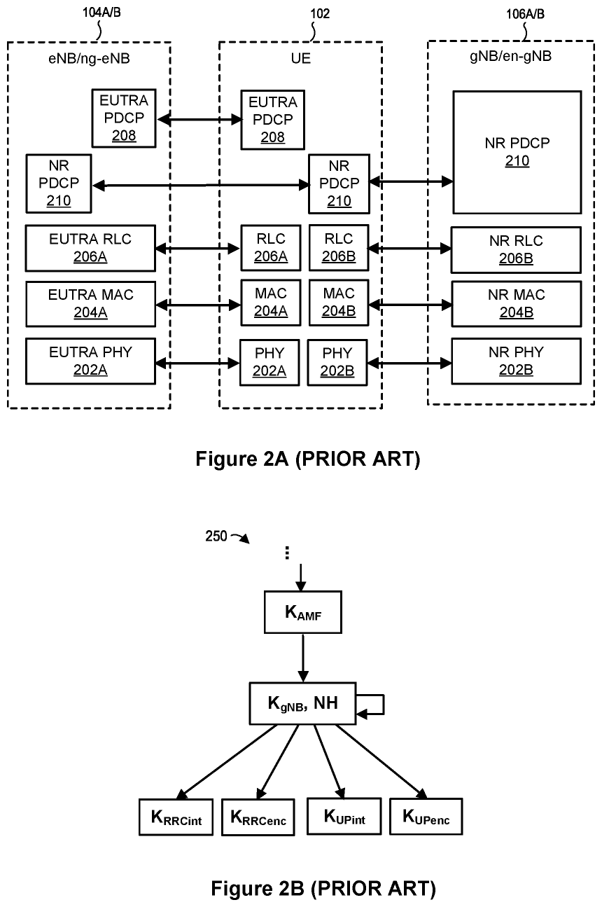

Next, FIG. 2A illustrates in a simplified manner a radio protocol stack according to which the UE 102 can communicate with an eNB/ng-eNB or a gNB. Each of the base stations 104A, 104B, or 106 can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE 102 operates in EUTRA/NR DC (EN-DC), with the BS 104A operating as a MeNB and the BS 106 operating as a SgNB, the network can provide the UE 102 with an MN-terminated bearer that uses EUTRA PDCP 208 or MN-terminated bearer that uses NR PDCP 210. The network in various scenarios also can provide the UE 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

For further clarity, FIG. 2B illustrates a fragment 250 of a security key hierarchy that includes the keys K_{AMF}, K_{gNB}, NH, K_{RRCint}, K_{RRCenc}, K_{UPint}, and K_{UPenc} The key K_{AMF}, which can have a certain dependency on one or more parameters of the corresponding CN, can serve (at least partially) as a parent to RAN keys such as the K_{gNB}, as well as the NH key. The K_{gNB} or the NH key can serve as the basis for generating a new version of the key K_{gNB}, i.e., K_{gNB}′ (e.g., K_{gNB}→K_{gNB}′ or NH→K_{gNB}′). The key K_{gNB} is used to generate the keys K_{RRCint}, K_{RRCenc}, K_{UPint}, and K_{UPenc} If the key K_{gNB}′ is generated, the key K_{gNB}′ is used to generate new versions of the keys K_{RRCint}, K_{RRCenc}, K_{UPint}, and K_{UPenc}.

To generate a security key, a module such as the MN security controller 132, the SN security controller 142, or the UE security controller 152 can use a suitable Key Derivation Function (KDF), which can include a set of functions specific to various keys. In some cases, the module applies the KDF to the current value of the key and uses one or more additional parameters such as counters for example.

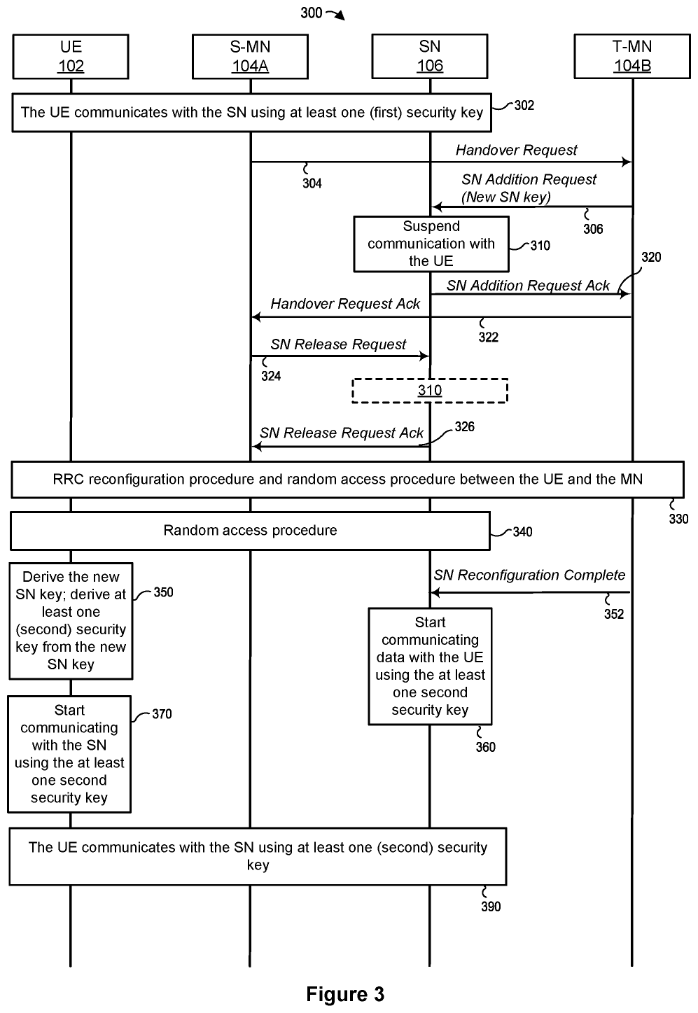

Several example scenarios in which the devices operating in the system of FIG. 1 manage one or more security keys are discussed next with reference to FIGS. 3-7.

Referring first to FIG. 3, the base station 104A in a scenario 300 operates as an S-MN that hands over the UE 102 to another MN, and accordingly is referred to as an S-MN 104A. The base station 106 operates as an SN and is referred to as an S-MN 106. The base station 104B operates as an MN to which the S-MN 104A hands over the UE 102, and is referred to as a T-MN 104B.

In the beginning of the scenario, the UE 102 operates in DC with the S-MN 104A and the SN 106. The UE 102 communicates 302 data (e.g., UL Data PDUs and/or DL Data PDUs) with the SN 106 and uses at least one first security key.

In some implementations, the UE 102 derives the at least one first security key based on a previous (or “old”) value of the SN key K_{SN}. The SN 106 derives the at least one first security key based on the old value SN key received from the S-MN 104A. The old SN key at the UE 102 is the same as the old SN key received from the S-MN 104A, and the at least one first security key at the UE 102 is the same as the at least one security key at the SN 106. When the SN 106 is implemented as a gNB, the old SN key is an old S-K_{gNB} key, and the new SN key is a new S-K_{gNB} key. When the SN 106 is implemented as a ng-eNB, the old SN key is an old S-K_{eNB} key and the new SN key is a new S-K_{eNB} key.

More generally, the first security key the UE 102 and the SN 106 derive are aligned according to any suitable security technique, so that the UE 102 can use the first security key to reverse the effect of applying the second security key at the SN 106, and the SN 106 can use the first security key to reverse the effect of applying the second security key at the UE 102. Similarly, when the UE 102 and the SN 106 derive a second security key discussed below, the second security key at the UE 102 and the SN 106 are aligned (e.g., identical).

The at least one first security key can include a first encryption key and/or a first integrity key. In some implementations, the first encryption key is a first user-plane encryption key (K_{UPenc}) and the first integrity key is a first user-plane integrity key (K_{UPinc}). In other implementations, the first encryption key is a first RRC encryption key (K_{RRCenc}) and the first integrity key is a first RRC integrity key (K_{RRCinc}). When the UE 102 is configured to enable integrity protection for a radio bearer via which the UE 102 transmits packets to the SN 106, the UE 102 uses the first integrity key to generate an integrity check code (e.g., message authentication code) for each of the UL packet(s). The UE 102 uses the first encryption key to encrypt the UL packet and its corresponding integrity check code. The UE 102 generates a UL Data PDU including the encrypted UL packet and its corresponding encrypted integrity check code (if generated). The UE 102 then transmits 302 the UL Data PDU to the SN 106 using the radio resources the S-MN 104A or the SN 106 have configured. When the UE 102 is configured to enable integrity protection for a radio bearer via which the UE 102 receives DL packet(s) from the SN 106, the SN 106 uses the first integrity key to generate an integrity check code (i.e., message authentication code) for each of the DL packet(s). The SN 106 uses the first encryption key to encrypt the DL packet and its corresponding integrity check code. The SN 106 generates a DL Data PDU including the encrypted DL packet and its corresponding encrypted integrity check code (if generated). The SN 106 then transmits 302 the DL Data PDU to the UE 102 using the radio resources the SN 106 has configured, or via the S-MN 104A.

The SN 106 receives 302 a UL Data PDU from the UE 102 and uses the first encryption key to decrypt the encrypted and optionally integrity protected UL packet to retrieve the UL packet and its corresponding integrity check code. If the integrity protection is enabled as described above, the SN 106 uses the first integrity key to perform an integrity check on the integrity check code of the UL packet. If the integrity check passes verification, or when the integrity protection is not enabled, and the UL packet is a user-plane packet, the SN 106 can send the UL packet to the CN 110 (e.g., S-GW 112 or UPF 122) or an edge server (not shown in the figures). If the UL packet does not pass the integrity check, and the UL packet is a user-plane packet, the SN 106 discards the UL packet. Further, if the UL packet passes the integrity check, and the UL packet is an RRC PDU, the SN 106 processes the RRC PDU. If the UL packet does not pass the integrity check, and the UL packet is an RRC PDU, the SN 106 can send an SN message to the S-MN 104A to indicate integrity check failure.

The UE 102 receives 302 a DL Data PDU from the SN 106 and uses the first encryption key to decrypt the encrypted and optionally integrity protected UL packet to retrieve the DL packet and its corresponding integrity check code (if integrity check is enabled). If the integrity protection is enabled as described above, the US 102 uses the first integrity key to perform an integrity check on the integrity check code of the DL packet. If the DL packet passes the integrity check or the integrity protection is not enabled, and the DL packet is a user-plane packet, the UE 102 can deliver the DL packet to an operating system (e.g., Android or iOS) of the UE 102. If the DL packet does not pass the integrity check and the DL packet is a user-plane packet, the SN 106 discards the DL packet. If the DL packet passes the integrity check and the DL packet is an RRC PDU, the UE 102 processes the RRC PDU. If the DL packet passes the integrity check and the DL packet is an RRC PDU, the UE 102 indicates integrity check failure in an RRC message (e.g., RRCConnectionReestablishmentRequest or RRCReestablishmentRequest) and transmits the RRC message to the S-MN 104A. The UE 102 may initiate a random access procedure to transmit the RRC message.

In the scenario of FIG. 3, the S-MN 104A determines that the UE 102 should hand over from the cell 124A to the cell 124B of the T-MN 104B. The S-MN 104A can make this determination based on measurement reports from the UE 102 or another suitable event. In response to the determination, the S-MN 104A sends 304 a Handover Request message to the T-MN 104B so as to start the handover procedure. In response to receiving 304 the Handover Request message, the T-MN 104B determines to retain the SN 106 for the DC communication of the UE 102. In response to determining that the UE 102 should operate in DC with the T-MN 104B and the SN 106, the T-MN 104B includes a new SN key K_{SN} in an SN Addition Request message and sends 306 the SN Addition Request message to the SN 106. The SN 106 derives at least one second security key based on the new SN key received from the T-MN 104B.

When the SN 106 receives 306 the SN Addition Request message, the SN 106 can identify that the SN 106 had configured the UE 102, according to the information included in the SN Addition Request message. In some implementations, the information includes a XnAP identity (ID) the SN 106 previously configured, and the SN 106 sends the XnAP ID to the S-MN 104A. The S-MN 104A can include the XnAP ID in the Handover Request message (event 304). In other implementations, the information includes a cell configuration of the SN 106 and a radio network temporary identifier (RNTI) the SN 106 had assigned to the UE 102.

The SN 106 suspends 310 communication with the UE 102 in response to the SN Addition Request message. In some implementations, the SN 106 suspends communicating data with the UE 102 by suspending transmission of data to the UE 102. In particular, when the SN 106 receives downlink data for the UE 102 from the CN 110 (not shown in FIG. 3 to avoid clutter), or when the SN 106 has downlink traffic already queued internally for the UE 102 after the event 306, the SN 106 stops transmitting downlink packets to the UE 102, as a part of the event 310. The SN 106 also can suspend reception of data from the UE 102, if the SN 106 or the S-MN 104A previously configured the UE 102 to transmit UL data to the SN 106. The SN 106 in this case discards UL data received from the UE 102 if the SN 106 suspends communication with the UE 102. Consequently, the SN 106 does not use the at least one second security key to communicate data with the UE 102 before the UE 102 starts using the at least one second security key. The SN 106 can associate the time when the UE 102 starts using the at least one second security key with a key alignment event discussed below.

In some implementations, when the SN 106 suspends 310 communication with the UE 102, the SN 106 determines the at least one first security key is no longer valid.

Next, the SN 106 sends 320 an SN Addition Request Acknowledge message to the T-MN 104B in response to the SN Addition Request message. In the implementation illustrated in FIG. 3, the SN 106 suspends 310 communication with the UE 102 after receiving 306 the SN Addition Request message but prior to sending 320 the SN Addition Request Acknowledge message. In other implementations, the SN 106 can suspend 310 communication with the UE 102 in response, in parallel with, or after sending 320 the SN Addition Request Acknowledge message.

In response to receiving 320 the SN Addition Request Acknowledge message, the T-MN 104B sends 322 the S-MN 104A a Handover Request Acknowledge message including an RRC reconfiguration message for handover to the T-SN 104A, which then sends 324 an SN Release Request message to the SN 106. In response, the SN 106 sends 326 an SN Release Request Acknowledge message to the S-MN 104A.

In some implementations, the T-MN 104B includes the RRC reconfiguration message in the Handover Request Acknowledge message (event 322). In one implementation, the T-MN 104B includes a security configuration (e.g., a SK-Counter) in the RRC reconfiguration message. In some implementations, the SN 106 includes configuration of at least one security algorithm in the SN Addition Request Acknowledge message (event 320). The UE 102 can derive the at least one second security key from the security configuration and the at least one security algorithm.

The UE 102 performs 330 an RRC reconfiguration procedure (which the S-MN 104A can initiate) with the S-MN 104A and the T-MN 104B. The UE 102 in this scenario may not have an uplink grant and performs 330 a random access procedure with the T-MN 104B. In particular, during the RRC reconfiguration procedure (event 330), the UE 102 receives from the S-MN 104A the RRC reconfiguration message that includes the security configuration. In response, the UE 102 performs 330 the random access procedure with the T-MN 104B and transmits a RRC reconfiguration complete message as a part of the RRC reconfiguration procedure to the T-MN 106 (event 330).

If the T-MN 104B is an eNB or an ng-eNB, the RRC reconfiguration procedure can be an RRC Connection Reconfiguration procedure defined in 3GPP TS 36.331. The RRC reconfiguration message is a RRCConnectionReconfiguration message and the RRC reconfiguration complete message is a RRCConnectionReconfigurationComplete message (both associated with the event 330). If the T-MN 104B is an gNB, the RRC reconfiguration procedure can be an RRC Reconfiguration procedure defined in 3GPP TS 38.331. The RRC reconfiguration message in this case is an RRCReconfiguration message and the RRC reconfiguration complete message is an RRCReconfigurationComplete message (both associated with the event 330),

As illustrated in FIG. 3 in dashed line, the event 310 in some implementations can occur after the SN receives 324 the SN Release Request message rather than at the time illustrated in FIG. 3 in solid line. In this case, the SN 106 can continue applying the at least one first security key until the SN 106 receives 324 the SN Release Request message.

With continued reference to FIG. 3, in response to the RRC reconfiguration complete message (event 330), the T-MN 104B sends 352 an SN Reconfiguration Complete message to the SN 106.

After the UE 102 performs 340 a random access procedure with the SN 106 in accordance with a SN configuration included in the RRC reconfiguration message (event 330), the UE 102 derives 350 a new SN key K_{SN} key in accordance with the security configuration in the RRC reconfiguration message. The UE 102 then derives 350 at least one second security key from the new SN key. Although event 350 occurs after event 340 in FIG. 3, event 350 in some implementations can occur before or during event 340. In other words, the UE 102 can derive the SN key and the at least one second security key before starting to apply the at least one second security key to downlink or uplink traffic. Although FIG. 3 depicts the event 330 occurring prior to event 340, these events can overlap in time or occur in the order opposite to the one shown.

In some implementations, the SN configuration configures physical random access channel (PRACH) resources, which the UE 102 uses to transmit a random access preamble. For example, the PRACH resources can include PRACH occasions and/or frequency resources. In one implementation, the SN configuration also can configure a dedicated random access preamble, and the UE 102 transmits the dedicated random access preamble to the SN 106 in the random access procedure (event 340). The SN 106 responds to the UE 102 with a random access response (RAR) message in response to the (dedicated) random access preamble (also event 340). The RAR message may include a preamble identity or identifier of the dedicated random access preamble. In another implementation, the SN configuration configures multiple random access preambles. The UE 102 selects a random access preamble from among the multiple random access preambles and transmits the UE selected random access preamble to the SN 106. The SN 106 sends to the UE 102 with a RAR message in response to the UE selected random access preamble (also event 340). The UE 102 then sends a first medium access control (MAC) PDU to the SN 106 using an uplink grant included in the RAR message. The UE 102 includes the RNTI in the first MAC PDU. In response to the RNTI received in the first MAC PDU, the SN 106 sends the UE 102 a downlink control information (DCI) with a cyclic redundancy check (CRC) scrambled with the RNTI on a physical downlink control channel (PDCCH). If the DCI assigns an uplink grant, the UE 102 uses the uplink grant to send a second MAC PDU excluding the RNTI to the SN 106. The UE 102 in some implementations does not include any UL Data PDU in the second MAC PDU. The UE 102 in other implementations includes a UL Data PDU in the second MAC PDU. The UE 102 can use the at least one second security key to generate at least one encrypted and optionally integrity-protected UL packet, includes the at least one encrypted and optionally integrity-protected UL packet in the UL Data PDU. If the DCI assigns a PDSCH, the UE 102 receives the PDSCH from the SN 106 according to the DCI and processes a third MAC PDU included in the PDSCH. The SN 106 can use the at least one second security key to generate at least one encrypted and optionally integrity-protected DL packet, include the at least one encrypted and optionally integrity-protected DL packet in a DL Data PDU, and include the DL Data PDU in the third MAC PDU.

In a further implementation, the SN configuration configures a random access preamble and an uplink grant associated to the random access preamble. The UE 102 transmits the random access preamble and a first MAC PDU using the uplink grant to the SN 106 in the random access procedure (event 340). The UE 102 includes the RNTI in the first MAC PDU. In response to the RNTI received in the first MAC PDU, the SN 106 transmits the UE 102 a DCI with a CRC scrambled with the RNTI on a PDCCH. If the DCI assigns an uplink grant, the UE 102 uses the uplink grant to send a second MAC PDU excluding the RNTI to the SN 106. The UE 102 in some implementations does not include any UL Data PDU in the second MAC PDU. The UE 102 in other implementations may include a UL Data PDU in the second MAC PDU. The UE 102 may use the at least one second security key to generate at least one encrypted and optionally integrity-protected UL packet, includes the at least one encrypted and optionally integrity-protected UL packet in the UL Data PDU. If the DCI assigns a PDSCH, the UE 102 receives the PDSCH from the SN 106 according to the DCI and processes a third MAC PDU included in the PDSCH. The SN 106 can use the at least one second security key to generate at least one encrypted and optionally integrity-protected DL packet, include the at least one encrypted and optionally integrity-protected DL packet in a DL Data PDU, and include the DL Data PDU in the third MAC PDU.

In some implementations, the SN 106 derives (event not shown in FIG. 3 to reduce clutter) the at least one second security key based on the new SN key received in the SN Addition Request message prior to performing 340 the random access procedure with the UE 102, in response to performing 340 the random access procedure, in response to receiving a random access preamble during the random access procedure (event 340), in response to receiving the first UL packet from the UE 102, or when the SN 106 determines to transmit the first DL packet to the UE 102.

The new SN key which the UE 102 derives is the same as the new SN key (i.e., the K_{SN} key) which the T-MN 104B derives and provides 306 to the SN 106 in the SN Addition Request Acknowledge message. The at least one second security key the UE 102 derives using the new key K_{SN} is the same as the at least one second security key the SN 106 derives using the new key K_{SN}.

The UE 102 starts 370 communicating data with the SN 106 using the at least one second security key during or after performing 340 the random access procedure. For example, the UE 102 can transmit and/or receive data units such as data PDUs on the user plane. Depending on the scenario, the UE 102 can apply encryption and/or integrity checking using the corresponding key(s). The SN 106 starts 360 communicating with the UE 102 using the at least one second security key during or after 340 the random access procedure. The key alignment event key for the SN 106 in this case can correspond to one of the messages of the random access procedure. Similar to the UE 102, the SN 106 can transmit and/or receive data units such as data PDUs on the user plane. Depending on the scenario, the SN 106 can apply encryption and/or integrity checking using the corresponding key(s). The UE 102 and the SN 106 then communicate 390 using the same (or, more generally, aligned) at least one second security key.

Similar to the first security key discussed above, the at least one second security key can include a second encryption key and/or a second integrity key. In some implementations, the second encryption key is a second user plane encryption key (K_{UPenc}) and the second integrity key is a second user plane integrity key (K_{UPinc}). In other implementations, the second encryption key is a second RRC encryption key (K_{RRCenc}) and the second integrity key is a second RRC integrity key (K_{RRCinc}). If the UE 102 is configured to enable integrity protection for a radio bearer via which the UE 102 transmits UL packet(s) to the SN 106, the UE 102 uses the second integrity key to generate an integrity check code (e.g., message authentication code) for each of the UL packet(s). The UE 102 uses the second encryption key to encrypt the UL packet and its corresponding integrity check code. The UE 102 generates a UL Data PDU including the encrypted UL packet and its corresponding encrypted integrity check code (if generated). The UE then transmits 390 the UL Data PDU to the SN 106 on radio resources configured by the S-MN 104A or the SN 106. When the UE 102 is configured to enable integrity protection for a radio bearer via which the UL packet(s) are to be transmitted to the SN 106, the SN 106 uses the second integrity key to generate an integrity check code (i.e., message authentication code) for each of the DL packet(s). The SN 106 uses the second encryption key to encrypt the DL packet and its corresponding integrity check code. The SN 106 generates a DL Data PDU including the encrypted DL packet and its corresponding encrypted integrity check code (if generated). The SN 106 then transmits 390 the DL Data PDU to the UE 102 on radio resources the SN 106 has configured, or via the S-MN 104A.

The SN 106 receives 302 a UL Data PDU from the UE 102 and uses the second encryption key to decrypt the encrypted and optionally integrity protected UL packet to retrieve the UL packet and its optionally integrity check code. If the integrity protection is enabled as described above, the SN 106 uses the first integrity key to perform an integrity check on the integrity check code of the UL packet. If the UL packet passes the integrity check or the integrity protection is not enabled, and the UL packet is a user-plane packet, the SN 106 can send the UL packet to the CN 110 or an edge server. If the UL packet does not pass the integrity check and the UL packet is a user-plane packet, the SN 106 discards the UL packet. If the UL packet passes the integrity check and the UL packet is an RRC PDU, the SN 106 processes the RRC PDU. If the UL packet does not pass the integrity check and the UL packet is an RRC PDU, the SN 106 can send an SN message to the T-MN 104B to indicate integrity check failure.

Further, the UE 102 receives 390 a DL Data PDU from the SN 106 and uses the second encryption key to decrypt the encrypted and optionally integrity protected UL packet to retrieve the DL packet and its corresponding integrity check code (if integrity protection is enabled). If the integrity protection is enabled as described above, the UE 102 uses the second integrity key to perform an integrity check on the integrity check code of the DL packet. If the DL packet passes the integrity check or the integrity protection is not enabled, and the DL packet is a user-plane packet, the UE 102 can deliver the DL packet to an operating system (e.g., Android or iOS). If the DL packet does not pass the integrity check and the DL packet is a user-plane packet, the UE 102 discards the DL packet. If the DL packet passes the integrity check and the DL packet is an RRC PDU, the UE 102 processes the RRC PDU. If the DL packet does not pass the integrity check and the DL packet is an RRC PDU, the UE 102 indicates integrity check failure in an RRC message (e.g., RRCConnectionReestablishmentRequest or RRCReestablishmentRequest message) and transmits the RRC message to the T-MN 104A. The UE 102 can perform a random access procedure to send the RRC message.

In some implementations, the UE 102 uses the at least one second security key to generate at least one encrypted and optionally integrity-protected UL packet, and includes the at least one encrypted and optionally integrity-protected UL packet in a UL Data PDU(s). The UE 102 transmits the UL Data PDU(s) to the SN 106. The SN 106 uses the at least one second security key to process the at least one encrypted and optionally integrity-protected UL packet in the received UL Data PDU(s). The UE 102 can transmit the UL Data PDU(s) on at least one physical uplink shared channel (PUSCH) to the SN 106. In one implementation, the SN 106 assigns a PUSCH by configuring an uplink grant in a random access response of the random access procedure (event 340) and transmit at least one downlink control information (DCI) on PDCCH(s), to assign the rest of the at least one PUSCH. In another implementation, the SN 106 may transmit at least one downlink control information (DCI) on PDCCH(s) to the UE 102 to assign the at least one PUSCH.

Further, the SN 106 can transmit DL Data PDU(s) to the UE 102 using the at least one second security key, during or after the random access procedure (event 340). The SN 106 uses the at least one second security key to generate at least one encrypted and optionally integrity-protected DL packet, and includes the at least one encrypted and optionally integrity-protected DL packet in the DL Data PDU(s). The UE 102 uses the at least one second security key to process the at least one encrypted and optionally integrity-protected DL packet in the received DL Data PDU(s), during or after the random access procedure (event 340).

In some implementations, the SN 106 starts 360 using the at least one second security key when the SN 106 receives the first one of the UL Data PDU(s) from the UE 102 during or after the random access procedure (event 340). More particularly, the SN 106 uses the at least one second security key to perform decryption and/or integrity check on the first encrypted and optionally integrity protected UL packet in the first UL Data PDU, and continues to use the at least one second security key with the subsequent encrypted and optionally integrity protected UL packets in UL Data PDU(s) received from the UE 102.

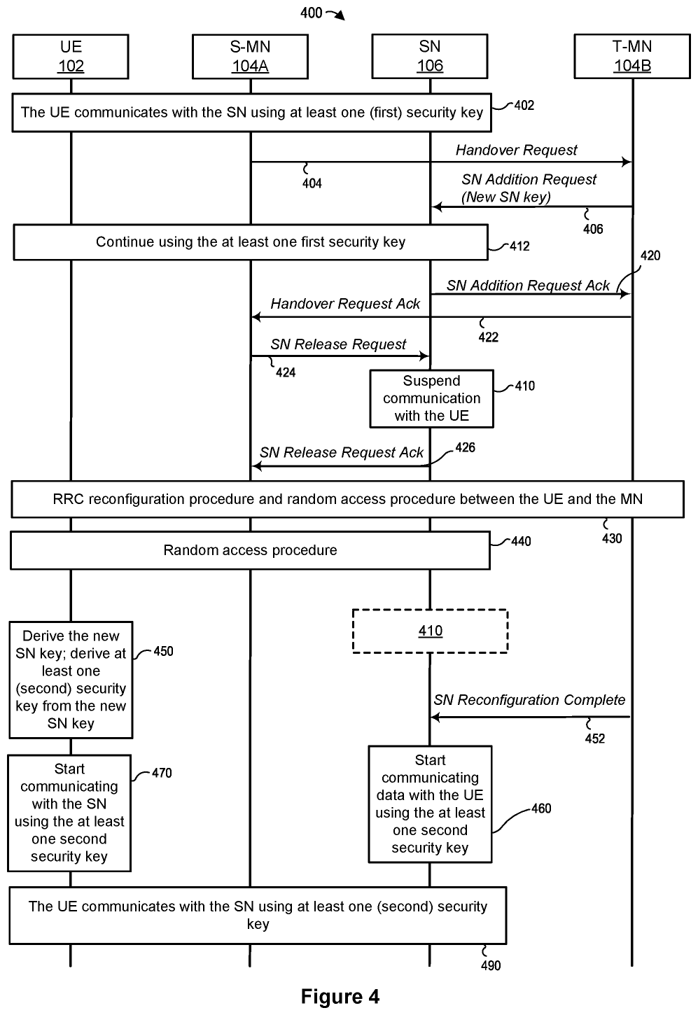

Next, FIG. 4 illustrates a generally similar scenario 400 that involves an inter-MN handover with the same SN. Events labeled with the same lower two digits in FIGS. 3 and 4 (e.g., 302 and 402, or 426 and 526) are similar and are not discussed below.

In the scenario of FIG. 4, the SN 106 continues to communicate 412 data with the UE 102 using the at least one first security key after receiving the new SN key from the T-MN 104B, so as to reduce the interruption of data communication between the UE 102 and the SN 106. Instead of suspending communication with the UE 102 in response to the SN Addition Request message (see event 310 in FIG. 3), the SN 106 continues to communicate with the UE 102 using the at least one first security key after receiving the new SN key from the T-MN 104A, for a period of time.

The SN 106 then suspends 410 communicating data with the UE 102 in response to the SN Release Request message (event 424). Thus, as compared with the scenario 300 of FIG. 3, the SN 106 uses the at least one first security key for the additional interval of time between the events 406 and 424. The SN 106 in this scenario still does not use the at least one second security key to communicate with the UE 102 before the UE 102 starts using the at least one second security key, and the UE 102 and the SN 106 accordingly use the same security key to communicate data. Depending on the particular implementation, the SN 106 can suspend 410 communicating data with the UE 102 in response to, in parallel with, or after transmitting the SN Release Request Acknowledge message (event 426).

In another implementation illustrated in dashed line, the SN 106 continues to communicate with the UE 102 using the at least one first security key until the random access procedure, and suspends 410 communicating data with the UE 102 in response to the random access procedure (event 440), e.g., upon receiving one of the inbound messages or transmitting one of the outbound messages associated with the random access procedure.

In some implementations or scenarios, event 452 can occur before event 410. In this case, the SN 106 can suspend 410 communicating data with the UE 102 in response to receiving 452 the SN Reconfiguration Complete message. In other implementations, the SN 106 can suspend 410 communicating data with the UE 102 at some time between events 424 and 440, or between events 424 and event 452 for example.

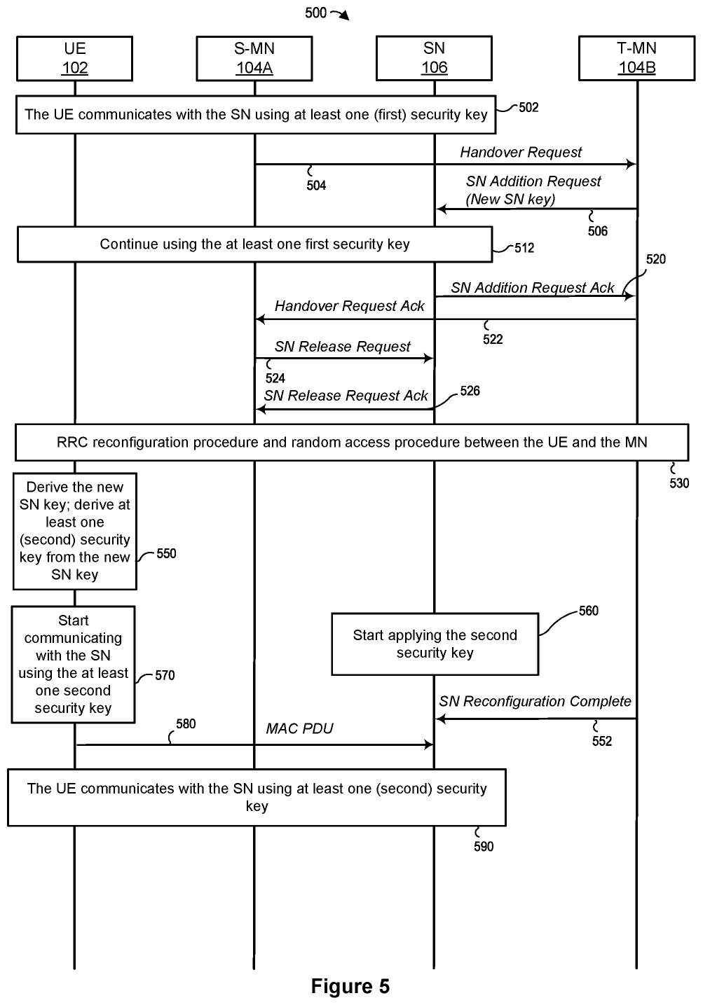

Now referring to FIG. 5, events labeled with the same lower two digits in FIGS. 3-5 (e.g., 302 and 502, or 426 and 526) are similar and are not discussed below. The UE 102 in a scenario 500 does not perform a random access procedure with the SN 106 because the RRC reconfiguration message (event 530) configures the UE 102 to not perform this procedure.

The UE 102 transmits 580 a Medium Access Control (MAC) PDU to the SN 106. In some implementations, the RRC reconfiguration message configures at least one preconfigured UL grant. The UE 102 sends 580 the MAC PDU on a physical UL shared channel (PUSCH) corresponding to the at least one preconfigured UL grant. In other implementations, the SN 106 sends a DCI on a PDCCH to assign a PUSCH to the UE 102, and the UE 102 sends 580 the MAC PDU on the PUSCH to the SN 106. In some implementations, the RRC reconfiguration message does not configure the PRACH resources. In other implementations, the RRC reconfiguration message still configures the PRACH resources. The UE 102 may determine to uses the PRACH resources as described above if the UE 102 fails to send the MAC PDU on the PUSCH to the SN 106. In one implementation, the UE 102 detects failure if the UE 102 does not receive a DCI with a CRC scrambled with the RNTI on a PDCCH from the SN 106 after sending the MAC PDU on the PUSCH. In another implementation, the UE 102 detects failure if the UE 102 does not receive a MAC PDU from the SN 106 after sending the MAC PDU on the PUSCH.

In one implementation, the SN 106 includes the at least one preconfigured UL grant in an SN configuration in the RRC reconfiguration message (event 530). The UE 102 accordingly can omit a random access procedure (cf. events 330 and 430 above) with the SN 106 in response to the at least one preconfigured UL grant. In another implementation, the SN 106 can explicitly indicate that the UE 102 should omit a random access procedure with the SN 106, in the SN configuration. The UE 102 omits a random access procedure with the SN 106 in response to the explicit indication.

In some implementations, the SN 106 starts 560 applying the at least one second security key for the first one of the UL Data PDUs the UE 102 sends to the SN 106. In particular, the SN 106 uses the at least one second security key to perform decryption and/or integrity check on the first encrypted and optionally integrity-protected UL packet in the first UL data PDU and continues to use the at least one second security key with the subsequent encrypted and optionally integrity protected UL packets in from the UE 102.

In one implementation, the UE 102 includes the first UL Data PDU in the MAC PDU at event 580. In another implementation, the UE 102 does not include any UL Data PDU in the MAC PDU at event 580. The UE 102 in this case transmits the UL Data PDU(s) to the SN 106 after transmitting the MAC PDU that does not include a UL Data PDU.

In other implementations, the SN 106 can transmit DL Data PDU(s) to the UE 102 using the at least one second security key after receiving 580 the MAC PDU or the PUCCH transmission from the UE 102. The SN 106 uses the at least one second security key to generate at least one encrypted and optionally integrity-protected DL packet, and includes the at least one encrypted and optionally integrity-protected DL packet in the one or more DL Data PDU(s). The UE 102 uses the at least one second security key to process the at least one encrypted and optionally integrity-protected DL packet in the received one or more DL Data PDU(s).

Further, in some implementations, event 552 can occur before event 580. In this case, the SN 106 can suspend communicating data with the UE 102 in response to receiving 552 the SN Reconfiguration Complete message. In other implementations, the SN 106 can suspend communication with the UE 102 at some time between events 524 and 580.

In some implementations, the SN 106 can receive a UE capability of the UE 102 from the S-MN 104A or the UE 102. The UE capability indicates that the UE 102 supports omitting a random access procedure with an SN or supports the at least one preconfigured UL grant in the SN configuration. The UE 102 can transmit the UE capability to the S-MN 104A, and the S-MN 104A forwards the UE capability to the SN 106. According to the UE capability, the SN 106 configures the UE 102 to not perform a random access procedure with the SN 106 and operate according to the scenario of FIG. 5 or configures the UE 102 the at least one preconfigured UL grant in the SN configuration. On the other hand, if the SN 106 does not receive the UE capability, the SN 106 configures the UE 102 to perform a random access procedure with the SN 106 and operate according to the scenario of FIG. 3 or FIG. 4 or does not configure the at least one preconfigured UL grant in the SN configuration.

In some implementations, the SN 106 suspends communication with the UE 102 in response to receiving 524 the SN Release Request message. In other implementations, the SN 106 suspends communication with the UE 102 in response to receiving 506 the SN Addition Request message.

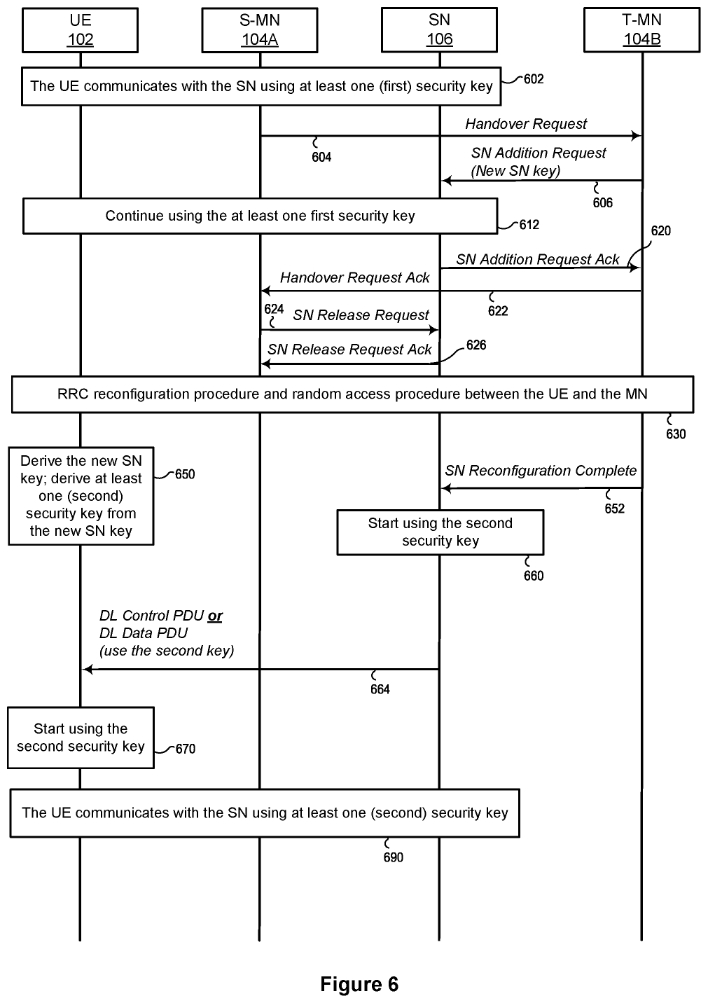

FIG. 6 illustrates a generally similar scenario 600 that involves an inter-MN handover with the same SN. Again, events labeled with the same lower two digits in FIGS. 3-6 (e.g., 302 and 602, or 426 and 626) are similar and are not discussed below.

In this scenario, the SN 106 does not suspend communication with the UE 102 in connection with the inter-MN handover that involves the same SN 106. As in the scenario of FIG. 5, the UE 102 does not perform a random access procedure with the SN 106 because the RRC reconfiguration message configures the UE with an option to omit this procedure. The SN 106 can indicate that the UE 102 can skip a random access procedure with the SN 106 in an SN configuration in the RRC reconfiguration message (event 630), as discussed above with reference to FIG. 5.

The SN 106 starts 660 applying the at least one second security key in response to, for example, receiving 652 the SN Reconfiguration Complete message. Upon making this determination, the SN 106 transmits 664 to the UE 102 a control PDU indicating using at least one second security key, according to one implementation. In another implementation, the SN 106 transmits 664 to the UE 102 a data PDU (rather than a control PDU) indicating using at least one second security key. In response to receiving 664 indication in the control PDU or data PDU, the UE 102 starts 670 using the at least one second security key.

In some scenarios, event 660 can occur after event 652 as shown in FIG. 6. In other scenarios, event 660 may occur before event 652. In some cases, the SN 106 can ensure that the UE 102 receives the RRC reconfiguration message (event 630) before transmitting 664 the control PDU or the data PDU. For example, the SN 106 can transmit 664 the control PDU or the data PDU upon receiving 652 the SN Reconfiguration Complete message. In another implementation, the SN 106 transmits the control PDU or the data PDU after a predetermined time T after receiving 606 the SN Addition Request message, receiving 624 the SN Release Request message, or receiving 652 the SN Reconfiguration Complete message. To this end, the SN 106 can utilize a timer with the expiration period T.

In some implementations, the control PDU or data PDU the SN 106 transmits 664 to the UE 102 explicitly or implicitly indicates that the SN 106 is no longer using the at least one first security key.

In one implementation, the SN 106 performs neither integrity protection nor encryption on the DL control PDU or DL data PDU of event 664. In another implementation, the SN 106 uses the at least one second key to generate an encrypted and optionally integrity protected DL packet. The SN 106 includes the encrypted and optionally integrity protected DL packet in the DL data PDU of event 664. The SN 106 uses a header of the DL data PDU (e.g., a field in the header) to indicate application of at least one second security key to DL packets. According to the indication of application of at least one second security key to DL packets, the UE 102 uses the at least one second key to decrypt the encrypted and optionally integrity protected DL packet received in the DL data PDU of event 664 to retrieve the DL packet.

The SN 106 can determine when to start using the at least one second security key. In some implementations, the SN 106 may still use the at least one first security key to communicate with the UE 102 for a period of time after the handover or receiving the SN Reconfiguration complete message. In some cases, the UE 102 may be configured to release connection with the SN 106 before the UE 102 and the SN 106 start using the at least one second security key.

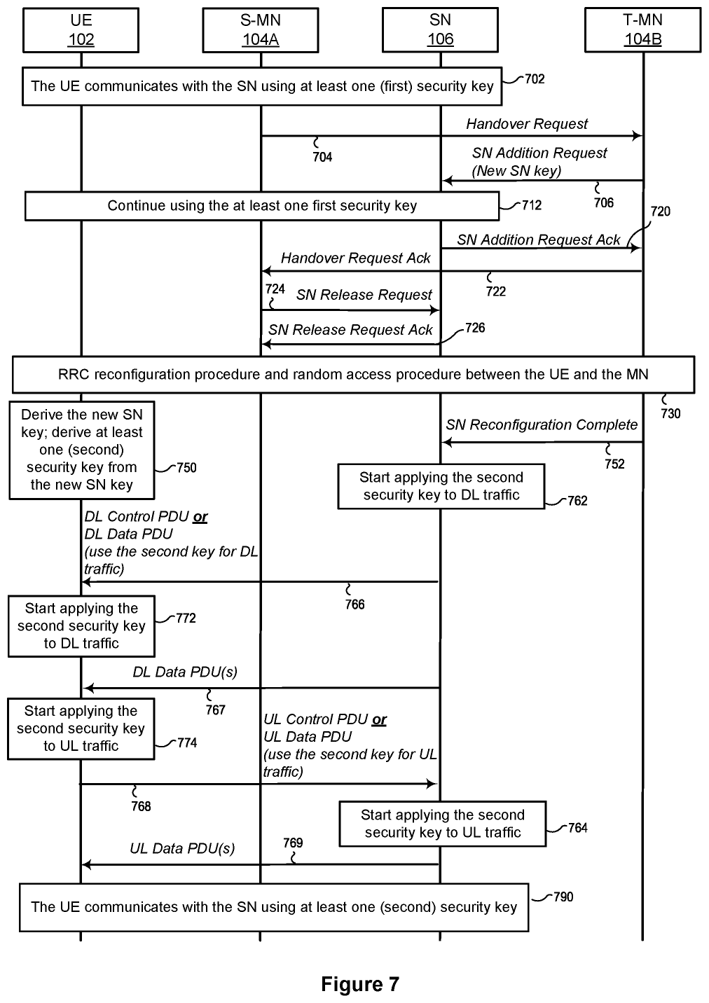

Next, FIG. 7 illustrates another similar scenario 700 that involves an inter-MN handover with the same SN. Events labeled with the same lower two digits in FIGS. 3-7 (e.g., 302 and 702, or 526 and 726) are similar and are not discussed below.

In this scenario, the SN 106 does not suspend communication with the UE 102 in connection with the inter-MN handover that involves the same SN 106. As in the scenario of FIG. 5, the UE 102 does not perform a random access procedure with the SN 106 because the RRC reconfiguration message configures that the UE can omit this procedure. The SN 106 can indicate that the UE 102 can skip a random access procedure with the SN 106 in an SN configuration in the RRC reconfiguration message (event 730), as discussed above with reference to FIG. 5.

The SN 106 begins 762 to use the at least one second security key, e.g., in response to, for example, receiving 752 the SN Reconfiguration Complete message. Upon making this determination, the SN 106 transmits 766 to the UE 102 a DL control PDU indicating application of at least one second security key to DL packets, according to one implementation. In another implementation, the SN 106 transmits 766 to the UE 102 a DL data PDU indicating using at least one second security key for DL packets.

In response to receiving 766 the indication in the DL control PDU or DL data PDU, the UE 102 determines (or starts) 772 to apply the at least one second security key to DL packets. After communicating 766 DL Control PDU, the UE 102 and the SN 106 can communicate DL packet(s) by using the at least one second security key for DL packets.

More particularly, after the event 766, the SN 106 can transmit 767 DL Data PDU(s), using the at least one second security key. The SN 106 uses the at least one second security key to generate at least one encrypted and optionally integrity protected DL packet and includes the at least one encrypted and optionally integrity-protected DL packet in the DL Data PDU(s). The UE 102 uses the at least one second security key to process the at least one encrypted and optionally integrity-protected DL packet in the received DL Data PDU(s).

The SN 106 can ensure the UE 102 receives (event 740) the RRC reconfiguration message before transmitting 766 the DL control PDU or the DL data PDU. For example, the SN 106 transmits the DL control PDU or the DL data PDU after receiving 752 the SN Reconfiguration Complete message. In another example, similar to the scenario of FIG. 6, the SN 106 transmits 766 the control PDU or the data PDU after a predetermined time T after receiving 706 the SN Addition Request message, receiving 724 the SN Release Request message, or receiving 752 the SN Reconfiguration Complete message. To this end, the SN 106 can utilize a timer with the expiration period T.

Likewise, the UE 102 determines 774 to use the at least one second security key after receiving the RRC reconfiguration or transmitting the RRC reconfiguration complete message (event 740), or in response to receiving 766 the DL control PDU or DL data PDU. Upon making this determination, the UE 102 transmits 768 to the SN 106 a UL control PDU or UL data PDU indicating application of at least one second security key to UL packets.

In response to receiving 768 the indication in the UL control PDU or UL data PDU, the SN 106 determines (or starts) 764 to use the at least one second security key for UL packets. The UE 102 and the SN 106 then communicate 769 UL packets using the at least one second security key. In particular, the UE 102 can use the at least one second security key to generate at least one encrypted and optionally integrity-protected UL packet and include the at least one encrypted and optionally integrity-protected UL packet in the UL Data PDU(s). The UE 102 transmits 769 the UL Data PDU(s) to the UE 102. The SN 106 uses the at least one second security key to process the at least one encrypted and optionally integrity-protected UL packet the received UL Data PDU(s).

In some scenarios, event 762 occurs after event 752 as shown in FIG. 7. In other implementations, event 762 occurs before event 752. In some implementations, the DL control PDU or DL data PDU of event 766 can explicitly or implicitly indicate the end of application of the at least one first security key to DL packets, and the UL control PDU or UL data PDU of event 768 can indicate the end of application of the at least one first security key to UL packets.

In one implementation, the UE 102 performs neither integrity protection nor encryption on the UL control PDU or UL data PDU of event 768. The SN 106 performs neither integrity protection nor encryption on the DL control PDU or DL data PDU of event 766. In another implementation, the UE 102 uses the at least one second key to generate an encrypted and optionally integrity protected UL packet. The UE 102 includes the encrypted and optionally integrity protected UL packet in the UL data PDU of event 768. The UE 102 uses a header of the UL data PDU to indicate application of at least one second security key to UL packets. According to the indication of application of at least one second security key to UL packets, the SN 106 uses the at least one second key to decrypt the encrypted and optionally integrity protected UL packet received in the UL data PDU of event 768 to retrieve the UL packet. The SN 106 uses the at least one second key to generate an encrypted and optionally integrity-protected DL packet. The SN 106 includes the encrypted and optionally integrity protected DL packet in the DL data PDU of event 766. The SN 106 uses a header of the DL data PDU to indicate application of at least one second security key to DL packets. According to the indication of application of at least one second security key to DL packets, the UE 102 uses the at least one second key to decrypt the encrypted and optionally integrity protected DL packet received in the DL data PDU of event 766 to retrieve the DL packet.

The SN 106 or the UE 102 can determine when to start using the at least one second security key. In some implementations, the SN 106 may still use the at least one first security key to communicate with the UE 102 for a period of time after the handover or receiving the SN Reconfiguration complete message. In some cases, the UE 102 may be configured to release connection with the SN 106 before the UE 102 and the SN 106 start using the at least one second security key.

The following additional considerations apply to the scenarios of FIGS. 3-7.

In some implementations, the S-MN 104A indicates 324, 424, 524, 624, or 724 in the SN Release Request message to the SN 106 that a UE context of the UE 102 in the SN 106 is to be retained. The SN 106 maintains the UE context in response to the indication. Due to the indication, the SN 106 retains the UE context until after the UE 102 receives a Context Release message from the S-MN 104A, following the SN Release Request message (event 724).

The SN 106 may generate the SN configuration, which in some implementations can be a cell group configuration (CellGroupConfig) or a RRCReconfiguration message, when the SN 106 is a gNB. In other implementations, the SN configuration can be an RRCConnectionReconfiguration message if the SN 106 is an ng-eNB.

In one implementation, the SN 106 configures the UE 102 to not reestablish PDCP (i.e., PDCP entity or entities (entity/entities)) for the radio bearer in the SN configuration. In response to the SN configuration, the UE 102 does not reestablish PDCP for the radio bearer. In another implementation, the SN 106 configures the UE 102 to reestablish PDCP for the radio bearer in the SN configuration. In response to receiving the SN configuration, the UE 102 reestablishes PDCP for the radio bearer. In a further implementation, the SN 106 configures the UE 102 to continue header compression operation (e.g., robust header compression (ROHC)) for the radio bearer in the SN configuration. In response to receiving the SN configuration, the UE 102 does not reset header compression protocol (e.g., ROHC protocol) for the radio bearer. In another implementation, the SN 106 configures the UE 102 to reset header compression operation for the radio bearer in the SN configuration. In response to receiving the SN configuration, the UE 102 resets the header compression protocol for the radio bearer. The SN 106 optionally can configure the header compression operation. To minimize interruption in data communication between the UE 102 and the SN 106 during the inter-MN handover, the SN 106 can configure the UE 102 to not reestablish PDCP nor to reset the header compression operation (if configured) for the radio bearer.

In some implementations, the SN 106 configures the UE 102 to not reestablish radio link control (RLC) entity/entities for the radio bearer in the SN configuration. In response to receiving the SN configuration, the UE 102 does not reestablish the RLC entity/entities for the radio bearer with the SN 106. In another implementation, the SN 106 configures the UE 102 to reestablish RLC entity/entities for the radio bearer in the SN configuration. In response to receiving this SN configuration, the UE 102 reestablishes the RLC entity/entities for the radio bearer with the SN 106.

Further, in some implementations, the SN 106 configures the UE 102 to not reset MAC in the SN configuration. In response to receiving this SN configuration, the UE 102 does not reset MAC (i.e., a SCG MAC entity) for the connection with the SN 106. In another implementation, the SN 106 configures the UE 102 to reset MAC in the SN configuration (i.e., the SN 106 does not indicate the UE 102 not to reset MAC). In response to receiving this SN configuration, the UE 102 resets MAC (i.e., a SCG MAC entity) for the connection with the SN 106.

The radio bearer in the examples above can be an SRB or an DRB which can be an SN-terminated bearer. The SN-terminated bearer can be a SCG bearer or a split bearer.

In some implementations, the SN 106 receives a UE capability of the UE 102 from the S-MN 104A or the UE 102. The UE capability indicates that the UE 102 supports omitting a random access procedure with an SN. The UE capability indicates also can indicate support of a control or data PDU that indicates the application of the at least one second security key. The UE 102 can transmit the UE capability to the S-MN 104A, and the S-MN 104A can forward the UE capability to the SN 106. According to the UE capability, the SN 106 configures the UE to not perform a random access procedure with the SN 106 and operate according to the scenarios of FIGS. 5-7. If the SN 106 does not receive the UE capability, the SN 106 configures the UE to perform a random access procedure with the SN 106 and operate according to the scenarios of FIGS. 3-5.

In some implementations, the S-MN 104A can receive a UE capability of the UE 102 from the UE 102 or from the CN 110 (e.g., the MME 114 or the AMF 154). The UE capability indicates the UE 102 supports to skip a random access procedure with an SN. According to the UE capability, the S-MN 104A can determine to not release the SN 106 for the UE 102 in response to receiving an indication of a handover to the T-MN 104B. In response to this determination, the S-MN 104A can determine to not perform another RRC reconfiguration procedure (i.e., a second RRC reconfiguration procedure) with the UE 102 to cause the UE to release the connection with the SN 106, prior to performing 33, 430, 530, 630, or 730 the RRC reconfiguration procedure for handover with the UE 102. Further, the S-MN 104A may determine to not send an SN Release Request message (see events 324, 424, 524, 625, or 724) to the SN 106 to request the SN 106 to stop serving the UE 102, in response to the determination. If the S-MN 104A does not receive the UE capability, the S-MN 104A can determine to release the SN 106 for the UE 102 in response to the indication of a handover to the T-MN 104B. In response to the determination, the S-MN 104A can perform another RRC reconfiguration procedure (i.e., a second RRC reconfiguration procedure) with the UE 102 in order to configure the UE 102 to release the connection with the SN 106, before performing 240, 340, 440, 540, 640, or 740 the RRC reconfiguration procedure for a handover with the UE 102. The S-MN 104A also can send an additional SN Release Request message to the SN 106 in order to request that the SN 106 stop serving the UE 102.

In some implementations, the S-MN 104A does not indicate in the 224, 324, 424, 524, 624, or 724 SN Release Request message to the SN 106 that a UE context of the UE 102 in the SN 106 is to be retained. In one implementation, the SN 106 releases the UE context in response to the SN Release Request message. Because the SN 106 does not receive from the S-MN 104A an indication indicating to keep the UE context, the SN 106 in another implementation releases the UE context in response to a Context Release message received from the S-MN 104A after the SN Release Request message.

During the second RRC reconfiguration procedure, the S-MN 104 transmits an RRC reconfiguration message (e.g., a RRCConnectionReconfiguration message or a RRCReconfiguration message) to the UE 102 in order to configure the UE 102 to release the connection with the SN 106. In response to the RRC reconfiguration message, the UE 102 releases the connection with the SN 106 (e.g., the UE performs multi-radio dual connectivity (MR-DC) release as specified in 3GPP TS 38.331 or NR-E-UTRA dual connectivity (NE-DC) release as specified in 3GPP TS 36.331).

A DL Data PDU in the examples above can be a PDCP Data PDU or an SDAP Data PDU. A UL Data PDU can be a PDCP Data PDU or an SDAP Data PDU. A control PDU can be a PDCP control PDU or an SDAP control PDU. A DL control PDU can be a PDCP Control PDU or an SDAP Control PDU. A UL Control PDU can be a PDCP Control PDU or an SDAP Control PDU. A UL packet can be an IP packet or an Ethernet packet. A DL packet also can be an IP packet or an Ethernet packet.

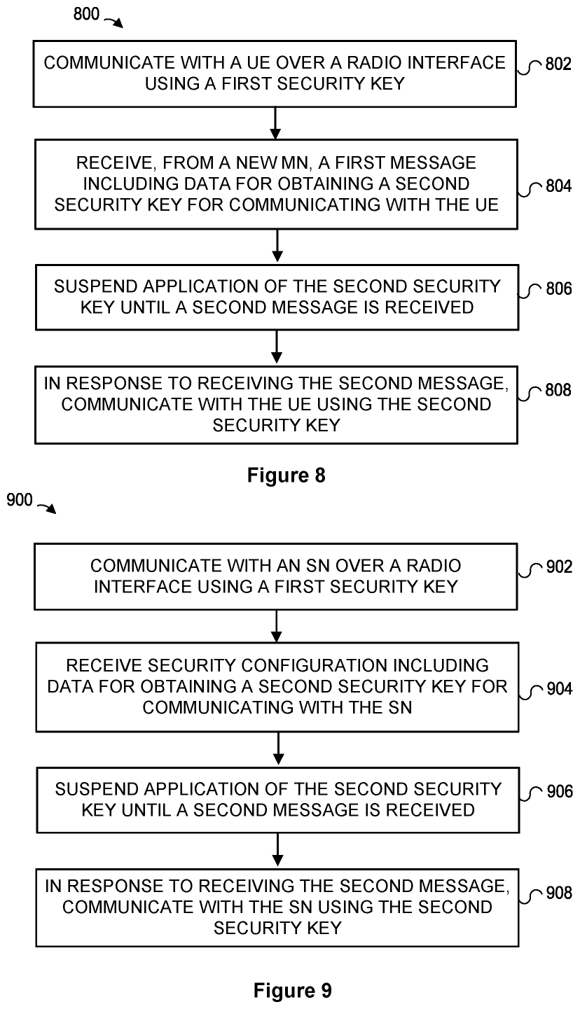

Now referring to FIG. 8, an example method 800 for managing a security key for communicating with a UE that goes through an inter-MN handover can be implemented in a base station. The method 800 is discussed below with an example reference to the SN 106, the S-MN 104A, the T-MN 104B, and the UE 102 of FIG. 1.

The method 800 begins at block 802, where the SN 106 communicates with the UE 102 over a radio bearer using a first security key (see events 302, 402, 502, 602, or 702). The first security key can be one of several security keys the SN 106 uses for encryption and/or integrity protection, on the user plane and/or control plane.

At block 804, the SN 106 can receive, from the T-MN 104B, a first message including data for obtaining a second security key, which the SN 106 will use to communicate with the UE 102 (see events 306, 406, 506, 606, and 706). The data for obtaining a second security key can be for example the new K_{SN} key. The second security key can be one of several security keys the SN 106 uses for encryption and/or integrity protection, on the user plane and/or control plane.

At block 806, the SN 106 can suspend application of the second security key until a second message is received. As discussed above, the SN 106 can generate the new security key using the new K_{SN} key at any time, but the SN 106 does not begin to apply the new security key until a subsequent key alignment event. In the example scenarios above, the key alignment event can include a message associated with the random access procedure (events 340, 440), an SN Reconfiguration Complete message received from the T-MN 104B (events 352, 452, 552, 652, or 752), a MAC PDU message received from the UE (event 580), or a UL data PDU or a UL control PDU (event 769).

As discussed above, when the SN 106 suspends application of the second security key, the SN in some implementations suspends communication (events 310, 410) with the UE 102 until the key alignment event or an intermediate event (see event 452), or the SN 106 can continue using the first security key until the key alignment event (events 412, 512, 612, or 712) until they key alignment event.

At block 808, the SN 106 starts to apply the second security key to traffic between the UE 102 and the SN 106 (events 360, 460, 560, 660, or 762/764). In some implementations, the SN 106 starts applying the second security key to traffic in both directions (events 360, 460, 560, and 660), while in other cases the SN 106 starts applying the second security key to traffic in different directions at different times (events 762 and 764).

FIG. 9 illustrates an example method 900 for managing a security key for communicating with an SN when a UE goes through an inter-MN handover. The method 900 can be implemented in the UE of FIG. 1 for example. The method 900 is discussed below with an example reference to the SN 106, the S-MN 104A, the T-MN 104B, and the UE 102 of FIG. 1.

The method 900 begins at block 902, where the UE 102 communicates with the SN 106 over a radio bearer using a first security key (see events 302, 402, 502, 602, or 702). The first security key can be one of several security keys the UE 102 uses for encryption and/or integrity protection, on the user plane and/or control plane.

At block 904, the UE 102 can receive a security configuration including data for generating a second security key for communicating with the SN 106 (events 330, 430, 530, 630, or 730). The data for obtaining a second security key can be for example the new K_{SN} key. The second security key can be one of several security keys the UE 102 uses for encryption and/or integrity protection, on the user plane and/or control plane.

At block 906, the UE 102 can suspend application of the second security key until a second message is received. As discussed above, the UE 102 can generate the new security key using the new K_{SN} key at any time, but the UE 102 does not begin to apply the new security key until a subsequent key alignment event. In the example scenarios above, the key alignment event can include a DL control PDU or a DL data PDU for example (events 664, 766).

At block 908, the UE 102 starts to apply the second security key to traffic between the UE 102 and the SN 106 (events 370, 470, 570, 670, or 772/774).

The following considerations apply to the discussion above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of aspects reflects a variety of the embodiments explicitly contemplated by the present disclosure.

Aspect 1. A method for secure communication at a base station operating as a secondary node (SN) for a user equipment (UE) in dual connectivity with a first master node (MN) and the SN, the method comprising: communicating, by processing hardware, with the UE over a radio interface using a first security key; receiving, by the processing hardware, a first message including data for obtaining a second security key for communicating with the UE, from a second MN; suspending, by the processing hardware, application of the second security key to downlink traffic to the UE until a second message is received; and in response to receiving the second message, communicating with the UE over the radio interface using the second security key.

Aspect 2. The method of aspect 1, wherein suspending the application of the second security key includes suspending downlink transmissions for a period of time.

Aspect 3. The method of aspect 2, wherein the second message is associated with a random access procedure between the UE and the SN.

Aspect 4. The method of aspect 2, including suspending downlink transmissions in response to receiving the first message.

Aspect 5. The method of aspect 2, further comprising: subsequently to receiving the first message, continuing to apply the first security key until a request to release the SN is received from the first MN; wherein suspending downlink transmissions is in response to receiving the request to release the SN.

Aspect 6. The method of aspect 2, further comprising: subsequently to receiving the first message, continuing to apply the first security key until a random access procedure between the UE and the SN; wherein suspending downlink transmissions for a period of time is in response to completing the random access procedure.

Aspect 7. The method of aspect 1, wherein the second message includes one of:

a transmission of a medium access control (MAC) protocol data unit (PDU) on a Physical Uplink Shared Channel (PUSCH), based on a pre-configured uplink grant, or a transmission on a Physical Uplink Control Channel (PUCCH).

Aspect 8. The method of aspect 1, wherein the second message relates to a status of the SN in the dual connectivity and is received from the first MN or the second MN.

Aspect 9. The method of aspect 1, further comprising: in response to receiving the second message, sending a downlink (DL) PDU including an indication that the SN is using the second security key, wherein the DL PDU is one of a DL data PDU or a DL control PDU.

Aspect 10. The method of aspect 1, further comprising: in response to receiving the second message, sending a DL PDU including an indication that the SN is using the second security key for DL traffic, wherein the DL PDU is one of a DL data PDU or a DL control PDU; and receiving an uplink (UL) PDU including an indication that the UE is using the second security key for UL traffic, wherein the UL PDU is one of an UL data PDU or an UL control PDU.

Aspect 11. The method of any of aspects 1-10, wherein the first message is a request to operate as an SN in dual connectivity with the second MN, to support an inter-MN handover of the UE.

Aspect 12. The method of any of aspects 1-11, wherein the data for obtaining the second security key includes a new SN key, the method further comprising generating the second security key based at least in part on the new SN key.

Aspect 13. The method of aspects 1-11, wherein: the second security key is an encryption key K_{UPenc}; and communicating with the UE includes applying the encryption key to one or more DL PDUs.

Aspect 14. The method of claim 13, further comprising: generating an integrity protection key K_{UPint} based at least in part on the new SN key, and applying the integrity protection key K_{UPint} to the one or more DL data PDUs.

Aspect 15. A base station comprising processing hardware and configured to implement a method of any of aspects 1-14.

Aspect 16. A method for secure communication at a UE operating in dual connectivity with a first MN and an SN, the method comprising: communicating, by processing hardware, with the SN over a radio interface using a first security key; receiving, by the processing hardware, security configuration including data for obtaining a second security key for communicating with the SN; suspending, by the processing hardware, application of the second security key to uplink traffic to the SN until a second message is received; and response to receiving the second message, communicating with the SN over the radio interface using the second security key.

Aspect 17. The method of aspect 16, wherein the second message includes a downlink DL PDU including an indication that the SN is using the second security key, wherein the DL PDU is one of a DL data PDU or a DL control PDU.

Aspect 18. The method of aspect 16, wherein: the second message includes a downlink DL PDU including an indication that the SN is using the second security key for downlink traffic, wherein the DL PDU is one of a DL data PDU or a DL control PDU; communicating with the SN using the second security key includes applying the second security key to the downlink traffic.

Aspect 19. The method of aspect 18, further comprising: subsequently to receiving the second message, transmitting an UL PDU including an indication that the UE is using the second security key for uplink traffic, wherein the UL PDU is one of a UL data PDU or a UL control PDU.

Aspect 20. A UE comprising processing hardware and configure to implement a method of any of aspects 16-19.

1. A method for secure communication at a base station operating as a secondary node (SN) for a user equipment (UE) in dual connectivity with a first master node (MN) and the SN, the method comprising:
communicating, by processing hardware, with the UE over a radio interface using a first security key;
receiving, by the processing hardware from a second MN, a first message including data for obtaining a second security key for communicating with the UE;
suspending, by the processing hardware, application of the second security key to downlink traffic to the UE until a second message is received; and
in response to receiving the second message, communicating with the UE over the radio interface using the second security key.

2. The method of claim 1, wherein suspending the application of the second security key includes suspending downlink transmissions for a predetermined period of time.

3. The method of claim 1, wherein the second message is associated with a random access procedure between the UE and the SN.

4. The method of claim 1, including suspending downlink transmissions in response to receiving the first message.

5. The method of claim 1, further comprising:
subsequently to receiving the first message, continuing to apply the first security key until a request to release the SN is received from the first MN;
wherein suspending downlink transmissions is in response to receiving the request to release the SN.

6. The method of claim 1, further comprising:
subsequently to receiving the first message, continuing to apply the first security key until a random access procedure between the UE and the SN;
wherein suspending downlink transmissions for a period of time is in response to completing the random access procedure.

7. The method of claim 1, wherein the second message includes, or relates to, one of:
(i) a transmission of a medium access control (MAC) protocol data unit (PDU) on a Physical Uplink Shared Channel (PUSCH), based on a pre-configured uplink grant,
(ii) a transmission on a Physical Uplink Control Channel (PUCCH), or
(iii) a status of the SN in the dual connectivity and is received from the first MN or the second MN.

8. The method of claim 1, further comprising:
in response to receiving the second message, sending a downlink (DL) PDU including an indication that the SN is using the second security key, wherein the DL PDU is one of a DL data PDU or a DL control PDU.

9. The method of claim 1, wherein the first message is a request to operate as an SN in dual connectivity with the second MN, to support an inter-MN handover of the UE.

10. The method of claim 1, wherein the data for obtaining the second security key includes a new SN key, the method further comprising generating the second security key based at least in part on the new SN key.

11. The method of claim 1, wherein:
the second security key is an encryption key K_{UPenc}; and
communicating with the UE includes applying the encryption key to one or more DL PDUs.

12. The method of claim 11, further comprising:
generating an integrity protection key K_{UPint} based at least in part on the new SN key, and
applying the integrity protection key K_{UPint} to the one or more DL data PDUs.

13. A method for secure communication at a UE operating in dual connectivity with a first MN and an SN, the method comprising:
communicating, by processing hardware, with the SN over a radio interface using a first security key;
receiving, by the processing hardware, security configuration including data for obtaining a second security key for communicating with the SN;
suspending, by the processing hardware, application of the second security key to uplink traffic to the SN until a second message is received; and
in response to receiving the second message, communicating with the SN over the radio interface using the second security key.

14. The method of claim 13, wherein the second message includes a downlink DL PDU including an indication that the SN is using the second security key, wherein the DL PDU is one of a DL data PDU or a DL control PDU.

15. A base station comprising processing hardware and configured to:
communicate a user equipment (UE) over a radio interface using a first security key, including operate as a secondary node (SN) for the UE in dual connectivity with a first master node (MN) and the SN;
receive, from a second MN, a first message including data for obtaining a second security key for communicating with the UE;
suspend application of the second security key to downlink traffic to the UE until a second message is received; and
in response to receiving the second message, communicate with the UE over the radio interface using the second security key.

16. The base station of claim 15, wherein to suspend the application of the second security key, the processing hardware is configured to:
suspend downlink transmissions for a predetermined period of time.

17. The base station of claim 15, wherein the second message is associated with a random access procedure between the UE and the SN.

18. The base station of claim 15, wherein the processing hardware is configured to suspend downlink transmissions in response to receiving the first message.

19. The base station of claim 15, wherein the processing hardware is further configured to:
subsequently to receiving the first message, continue to apply the first security key until a request to release the SN is received from the first MN;
wherein suspending downlink transmissions is in response to receiving the request to release the SN.

20. The base station of claim 15, wherein the processing hardware is further configured to:
subsequently to receiving the first message, continue to apply the first security key until a random access procedure between the UE and the SN;
wherein suspending downlink transmissions for a period of time is in response to completing the random access procedure.
